(19) United States
(12) Patent Application Publication
(10) Pub. No.: US 2014/0067822 A1
(43) Pub. Date: Mar. 6, 2014

(54) SYSTEM AND METHOD FOR SELECTIVE INDEXING OF CONTENT

(71) Applicant: Toshiba Samsung Storage Technology Korea Corporation, Suwon-si (KR)

(72) Inventors: Yu Hwan LEE, Suwon-si (KR); Young Woo LEE, Suwon-si (KR)

(73) Assignee: Toshiba Samsung Storage Technology Korea Corporation, Suwon-si (KR)

(21) Appl. No.: 14/018,510

(22) Filed: Sep. 5, 2013

(30) Foreign Application Priority Data
Sep. 6, 2012 (KR) 10-2012-0098682

(51) Int. Cl. G06F 17/30

(52) U.S. Cl. CPC G06F 17/30312
USPC 707/741

(57) ABSTRACT

Provided are a system and method for selective indexing of content. The system includes an indexing mode identifier to identify an indexing mode of content in a storage device selected by a user, and a content indexing unit to index the content, based on the indexing mode. By providing multiple indexing modes, the system can provide multiple options of indexing the content based on speed of indexing and level of detail of the indexing.

### CROSS-REFERENCE TO RELATED APPLICATION

This application claims the benefit under 35 USC 119(a) of Korean Patent Application No. 10-2012-0098682, filed on Sep. 6, 2012, in the Korean Intellectual Property Office, the entire disclosure of which is incorporated herein by reference for all purposes.

### BACKGROUND

1. Field

The following description relates to a system and method for selective indexing of content, and more particularly, to a system for indexing content that receives an indexing mode, and indexes the content based on the indexing mode.

2. Description of Related Art

In general, a media device may index content for sharing. The media device may provide a content list to a user, through the indexing of the content. For example, indexing may generate a thumbnail corresponding to the content in order to efficiently provide the content to a user. The thumbnail may refer to a file generated for the user to verify the content using a codec corresponding to the content.

However, typically the indexing occupies a predetermined period of time based on system specifications, storage capacity, an amount of content, and resources. As a result, indexing may take a significant amount of time. Also, a significant load may occur on a process during the indexing. Accordingly, an amount of work traffic of the process may be increased due to the significant load.

### SUMMARY

In an aspect, there is provided an apparatus for indexing content, the apparatus including an indexing mode identifier configured to identify an indexing mode of content included in a storage device, the indexing mode being selected by a user from among a plurality of indexing modes, and an indexer configured to index the content of the storage device based on the identified indexing mode.

The indexing mode may comprise a first indexing mode in which a process of generating a thumbnail of the content is not performed for the content included in the storage device.

The indexing mode may comprise a second indexing mode in which a same thumbnail is generated and applied to the content included in the storage device.

The indexing mode may comprise a third indexing mode in which a respective thumbnail corresponding to individual pieces of content is generated and applied to the individual pieces of the content included in the storage device.

The indexing mode may comprise at least one of a first indexing mode in which a process of generating a thumbnail of the content is not performed for the content included in the storage device, a second indexing mode in which a same thumbnail is generated and applied to the content included in the storage device, and a third indexing mode in which a respective thumbnail corresponding to individual pieces of content is generated and applied to the individual pieces of the content included in the storage device.

The indexer may be further configured to verify a codec for playing the content, and if the codec is absent, search for a codec corresponding to the content and store information about the content.

The information about the content may comprise at least one of a file size, a resolution, a playback time, a genre, an album, an artist, and a format of the content.

The indexer may be further configured to play content, using the codec, and generate a thumbnail representing the content based on the played content.

The indexer may not perform a process of generating a thumbnail for the content, based on the indexing mode selected by the user.

The indexer may be further configured to generate a same thumbnail for all of the content, based on the indexing mode selected by the user.

The indexer may be further configured to generate a respective thumbnail corresponding to individual pieces of content, based on the indexing mode selected by the user.

The indexer may be configured to generate a thumbnail using a still frame for representing the content and a successive frame.

In an aspect, there is provided a method for indexing content, the method including identifying an indexing mode of content included in a storage device, the indexing mode being selected by a user from among a plurality of indexing modes, and indexing the content of the storage device based on the identified indexing mode.

The indexing mode may comprise a first indexing mode in which a process of generating a thumbnail of the content is not performed.

The indexing mode may comprise a second indexing mode in which a same thumbnail is generated and applied to the content included in the storage device.

The indexing mode may comprise a third indexing mode in which a respective thumbnail corresponding to individual pieces of content is generated and applied to the individual pieces of the content included in the storage device.

The indexing mode may comprise at least one of a first indexing mode in which a process of generating a thumbnail of the content is not performed for the content included in the storage device, a second indexing mode in which a same thumbnail is generated and applied to the content included in the storage device, and a third indexing mode in which a respective thumbnail corresponding to individual pieces of content is generated and applied to the individual pieces of the content included in the storage device.

The indexing of the content may comprise verifying a codec for playing the content, and if the codec is absent, searching for a codec corresponding to the content and storing information about the content.

The information about the content may comprise at least one of a file size, a resolution, a playback time, a genre, an album, an artist, and a format.

The indexing of the content may comprise playing the content using a codec for playing the content, and generating a thumbnail for representing the content based on the played content.

Other features and aspects will be apparent from the following detailed description, the drawings, and the claims.

### BRIEF DESCRIPTION OF THE DRAWINGS

FIG. 1 is a diagram illustrating an example of an indexing system.

FIG. 2 is a diagram illustrating another example of an indexing system.

FIG. 3 is a diagram illustrating an example of the indexing system operating in a first indexing mode.

FIG. 4 is a diagram illustrating an example of the indexing system operating in a second indexing mode.

FIG. 5 is a diagram illustrating an example of the indexing system operating in a third indexing mode.

FIG. 6 is a diagram illustrating an example of a process of generating a thumbnail based on content.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

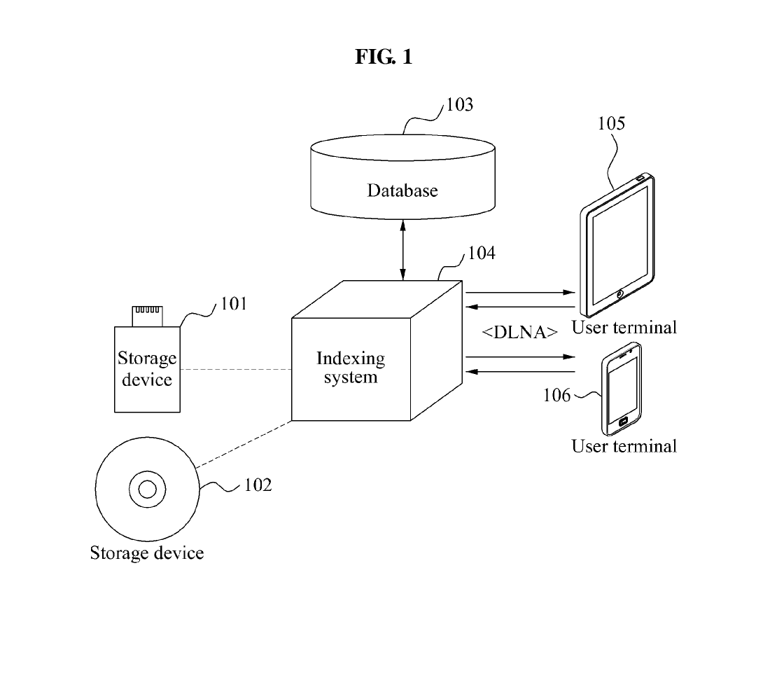

FIG. 1 illustrates an example of an indexing system 104.

Referring to FIG. 1, storage devices 101 and 102, the indexing system 104, and user terminals 105 and 106 are configured independently for convenience of explanation. The storage devices 101 and 102 may include content associated with an audio, a video, a photograph, and the like. As an example, the storage devices 101 and 102 may be any type of device for storing data, such as, a universal serial bus (USB) device, a compact disc-read only memory (CD-ROM), a digital versatile disc-read only memory (DVD-ROM), a Blue-Ray disc, and the like. The indexing system 104 may be connected to the storage devices 101 and 102, and store content associated with audio, video, a photograph, and the like, which may be included in the storage devices 101 and 102. In one example, the indexing system 104 may store the content as a digital living network alliance (DLNA) digital media server (DMS). The indexing system 104 may index content to share the content with the user terminals 105 and 106.

As an example, the indexing system 104 may be an apparatus such as a computer, a server, a terminal, a game console, a television, a storage apparatus, and the like. The indexing system 104 may be wired or wirelessly connected to the storage devices and the terminals.

The user terminals 105 and 106 may share content with the indexing system 104. The user terminals 105 and 106 may be home network apparatuses for sharing content in a home network. As an example, a user terminal may be a personal computer (PC), a laptop, a television (TV), an audio player, or a mobile terminal such as a mobile phone, a tablet PC, a personal digital assistant (PDA), and the like. The indexing system 104 may share content with the home network apparatus, for example, the user terminals 105 and 106, as the DLNA DMS.

For example, the indexing system 104 may be provided with content from the storage devices 101 and 102. The indexing system 104 may store the content in a database 103. The indexing system 104 may index the content stored in the database 103, and share the indexed file with the user terminals 105 and 106. As an example, the indexing system 104 may be a DLNA DMS, and may share the content with a home network apparatus such as the user terminals 105 and 106, connected to the home network.

According to various aspects, the indexing system 104 may index the content based on an indexing mode selected by a user.

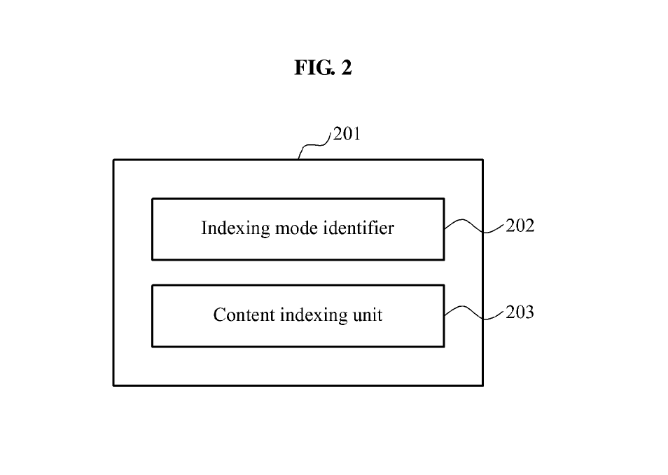

FIG. 2 illustrates another example of an indexing system 201.

Referring to FIG. 2, the indexing system 201 includes an indexing mode identifier 202 and a content indexing unit 203. The indexing mode identifier 202 may identify an indexing mode selected by a user. In this instance, the indexing mode may be selectively determined based on a user environment. The indexing mode identifier 202 may identify an indexing mode selected from among a plurality of indexing modes, for example, a first indexing mode, a second indexing mode, and a third indexing mode.

For example, the first indexing mode is an indexing mode for omitting a process of generating a thumbnail of content. Here, the first indexing mode may reduce a period of time for providing the content to the user by omitting the process of generating of the thumbnail.

The second indexing mode is an indexing mode that generates a single thumbnail for encompassing content, and applies the generated thumbnail to the content included in the indexing system 201. For example, the indexing system 201 may reduce a period of time for providing content to the user by generating a default thumbnail applicable to all content, based on the second indexing mode. Also, when new content is added, the indexing system 201 may not generate an additional thumbnail, but instead may apply a thumbnail generated in advance.

The third indexing mode is an indexing mode for generating a thumbnail corresponding to individual pieces of content, respectively. The third indexing mode may reduce issues, for example, debugging that may occur during playback of the content because in the third indexing mode the indexing system 201 generates a thumbnail corresponding to all the content included in the indexing system 201. Also, the third indexing mode may refer to an indexing method as a basis of indexing content.

The content indexing unit 203 may index content based on the indexing mode identified from the indexing mode identifier 202. For example, the content indexing unit 203 may verify a presence of a codec for playing content in order to index the content. The indexing of the content may be performed by playing the content.

When the codec for playing the content is absent, the content indexing unit 203 may search for the codec for playing the content, and store information on the content. The content indexing unit 203 may play the content using the codec, and generate a thumbnail representing the content from the content played.

The content indexing unit 203 may omit a process of generating the thumbnail of the content, based on the first indexing mode. In this example, the content indexing unit 203 may provide the content rapidly, by omitting the process of generating the thumbnail of the content.

The content indexing unit 203 may generate a thumbnail for encompassing content, based on the second indexing mode. In this example, the content indexing unit 203 may generate a single thumbnail applicable to all the content included in the indexing system 201 and thus, may not generate an additional thumbnail.

The content indexing unit 203 may generate a thumbnail corresponding to each individual piece of content in the third indexing mode. In this example, the third indexing mode may generate a thumbnail corresponding to an individual piece of content included in the indexing system 201 thus generating a thumbnail that is more appropriate for the particular content.

Also, the content indexing unit 203 may perform or omit the process of generating the thumbnail of the content, through playing the content based on the indexing mode.

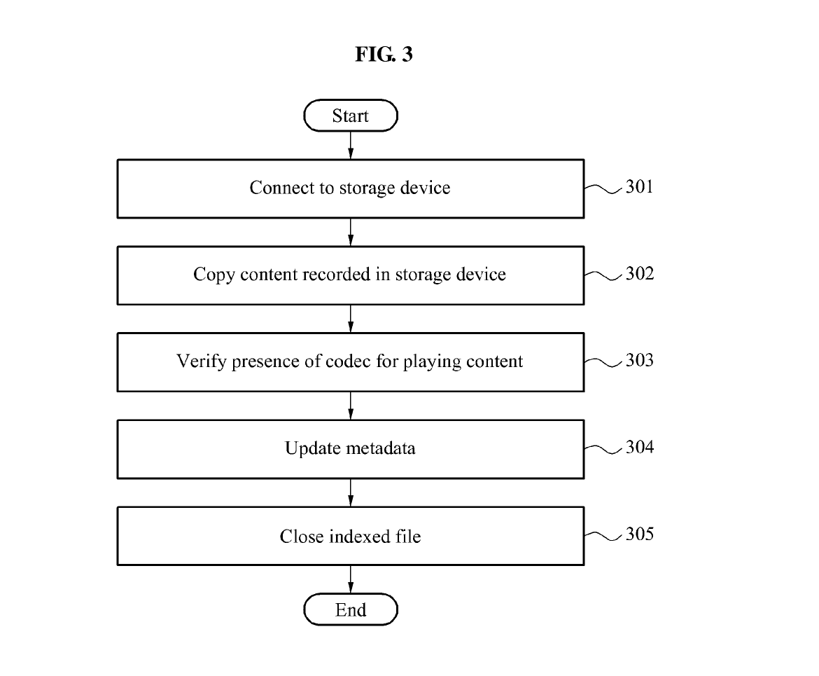

FIG. 3 illustrates an example of the indexing system operating in a first indexing mode.

FIG. 3 illustrates an example in which a user selects the first indexing mode. In this example, the first indexing mode may perform a series of operations for indexing content without generating a thumbnail to represent the content in a process of indexing the content.

In 301, an indexing system connects to a storage device including content such as audio, video, a photograph, and the like. For example, the storage device may be a device for storing data, such as a USB device, a CD-ROM, a DVD-ROM, a Blue-Ray disc, and the like.

In 302, the indexing system copies the content associated with the audio, the video, and the photograph included in the storage device. The indexing system may store the copied content in a database for storing content. In one example, the indexing system may store the content associated with the audio, the video, and the photograph as a DLNA DMS.

In 303, the indexing system verifies a presence of a codec for playing content on the copied content. For example, the indexing system may play content using a codec. Therefore, the indexing system may verify whether a file is able to play the content, based on the presence of the codec. That is, the indexing system may verify the presence of the codec to decode content encoded to an original file in a digital scheme.

In 304, the indexing system updates metadata based on the presence of the codec. For example, if the codec for playing the content is absent, the indexing system may search for a codec corresponding to the content, and store information about the content. The information may include a type of the codec, a file size, a resolution, a play time, a genre, an album, an artist, a format, and the like. Also, the indexing system may include data associated with metadata of a hypertext transfer protocol (HTTP) Get, aside from the information of the content using the codec. In 305, the indexing system closes an indexed file.

In this example, while performing content sharing between the DLNA DMS and a home network apparatus, the indexing system in the first indexing mode may not perform a process of generating a thumbnail for a series of contents. Accordingly, the first indexing mode may allow the user to quickly view desired content by removing the process of indexing.

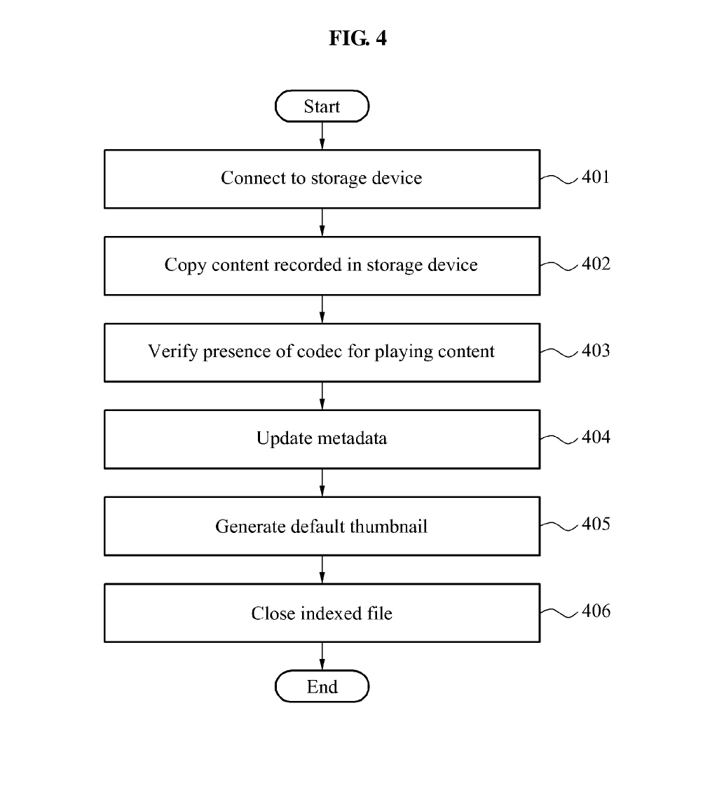

FIG. 4 illustrates an example of the indexing system operating in a second indexing mode.

FIG. 4 illustrates an example in which a default thumbnail is generated, and the generated default thumbnail is applied to all content. In this example, while operating in the second indexing mode the indexing system may index the all of the content to the default thumbnail, by applying the default thumbnail to all the content, rather than generating a thumbnail corresponding to individual pieces of content. Here, the default thumbnail may be determined based on the content or determined irrespective of the content.

In 401, the indexing system connects to the storage device including content. In 402, the indexing system copies the content included in the storage device to the indexing system and stores the content. For example, a storage space for storing the content may be configured separately from the indexing system.

In 403, the indexing system verifies a presence of a codec for playing the content. Also, the indexing system may verify the presence of the codec for playing the content, and play the content, based on the verified presence of the codec.

In 404, the indexing system updates metadata of the content. For example, if the codec is absent, the indexing system may search for a codec corresponding to the content, and also store information about the content including the type of codec.

In 405, the indexing system generates a default thumbnail applicable to all content included in the indexing system. The indexing system may generate a thumbnail of the played content, by playing the content. In one example, the default thumbnail may refer to a thumbnail representing the played or unplayed content. As another example, the default thumbnail may not represent the content included in the indexing system. In 406, the indexing system closes an indexing file.

In this example, a period of time for indexing may be decreases, and communication traffic may decreased when transmitting data to an external terminal because the indexing system operating in the second indexing mode applies the default thumbnail to all content while in the second indexing mode.

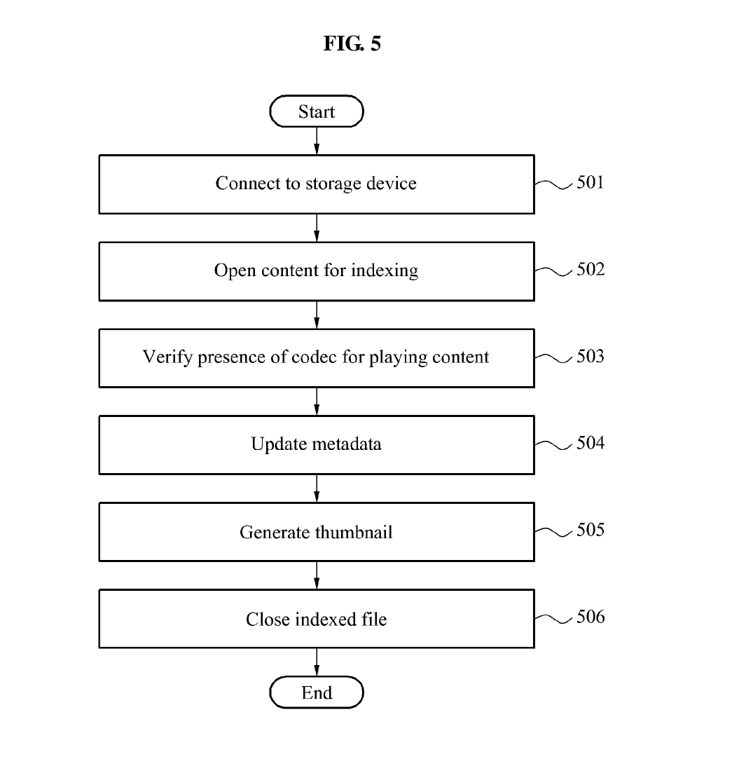

FIG. 5 illustrates an example of the indexing system operating in a third indexing mode.

FIG. 5 illustrates an example of indexing in which a thumbnail is generated based on individual pieces of content, respectively. In this example, the third indexing mode may generate the thumbnail corresponding to all the content included in an indexing system, and minimize issues occurring during playback of the content, such as, debugging. However, a load due to the indexing may increase rapidly in the third indexing mode in comparison to the first and second indexing modes.

In 501, the indexing system connects to a storage device including content. The content included in the storage device may be copied and stored in the indexing system. By way of example, the storage device may be configured separately from the indexing system.

In 502, the indexing system opens content for indexing. In 503, the indexing system verifies a presence of a codec for playing content. Also, the indexing system may verify the codec for playing the content, and play the content, based on the verified presence of the codec.

In 504, the indexing system updates metadata of the content. When the codec is absent, the indexing system may search for a codec corresponding to the content, and store information about the content such as a codec type, a file size, a resolution, a play time, a genre, an album, an artist, a format of the content, and the like.

In 505, the indexing system may generate the thumbnail corresponding to the individual pieces of content, respectively. The indexing system may play all the content included in the indexing system, and generate a thumbnail representing each respective piece of content, using the content played. In this example, a period of time a user waits for the content may increase as the indexing system generates the thumbnail corresponding to the individual pieces of content. However, the indexing system may minimize issues occurring during the play time of the content, such as, debugging, subsequent to generation of the thumbnail corresponding to the individual pieces of content. When the process of generating the thumbnail is completed with respect to all of the content, the indexing system closes an indexed file in 506.

The aforementioned processes of FIGS. 3 through 5 may be performed in the indexing system in parallel.

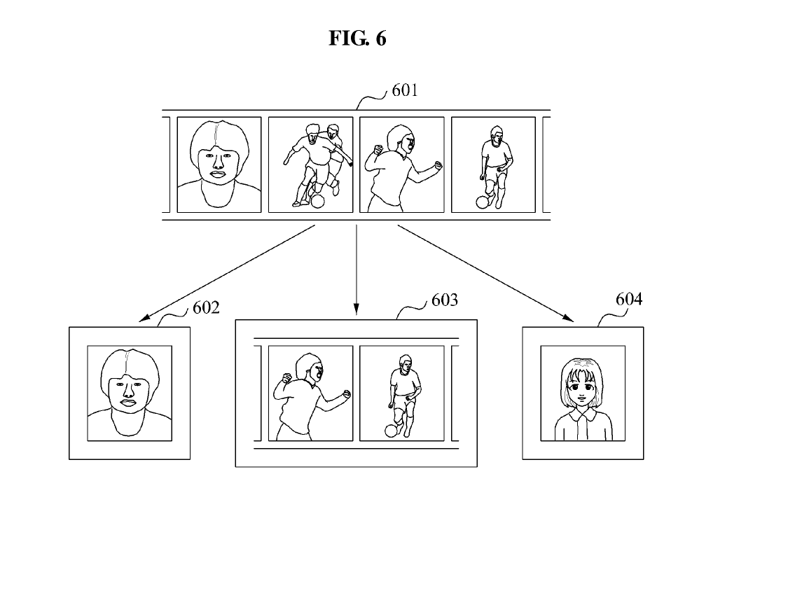

FIG. 6 illustrates an example of a process of generating a thumbnail. In this example, the thumbnail may be generated using a still frame representing content, a successive frame, or a frame not associated with the content.

Referring to FIG. 6, an indexing system may perform indexing by playing the content 601. For example, the indexing system may generate a thumbnail 602 associated with the still frame, a thumbnail 603 associated with the successive frame, and a default thumbnail 604 unassociated with the content, by playing the content 601.

When the content is configured by a plurality of frames, the thumbnail 602 associated with a single frame from among the frames included in the content 601 may be generated. Also, the thumbnail 603 associated with at least two frames from among the frames included in the content 601 may be generated. Further, the default thumbnail 604 unassociated with the content 601 may be generated.

In this example, the thumbnail 602 and the thumbnail 604 are indexing results in the form of a still image with respect to the content 601. The thumbnail 603 is an indexing result in the form of a moving image with respect to the content 601.

According to an aspect, it is possible to index content in an indexing mode selected by a user. According to another aspect, it is possible to verify a presence of a codec for playing content, and when the codec is absent, the codec corresponding to the content may be searched for, and information of the content may be stored.

According to various aspects, in a first indexing mode, an indexing system may not generate a thumbnail corresponding to the content. In a second indexing mode, the indexing system may apply the same thumbnail to all content included in a storage device. In a third indexing mode, the indexing system may apply a respective thumbnail to individual pieces of content.

According to still another aspect, it is possible to generate a thumbnail from content by playing the content. For example, it is possible to generate a thumbnail using a still frame representing content, a successive frame, or a frame unassociated with content.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for indexing content, the apparatus comprising:
an indexing mode identifier configured to identify an indexing mode of content included in a storage device, the indexing mode being selected by a user from among a plurality of indexing modes; and
an indexer configured to index the content of the storage device based on the identified indexing mode.

2. The apparatus of claim 1, wherein the indexing mode comprises:
a first indexing mode in which a process of generating a thumbnail of the content is not performed for the content included in the storage device.

3. The apparatus of claim 1, wherein the indexing mode comprises:
a second indexing mode in which a same thumbnail is generated and applied to the content included in the storage device.

4. The apparatus of claim 1, wherein the indexing mode comprises:
a third indexing mode in which a respective thumbnail corresponding to individual pieces of content is generated and applied to the individual pieces of the content included in the storage device.

5. The apparatus of claim 1, wherein the indexing mode comprises at least one of:
a first indexing mode in which a process of generating a thumbnail of the content is not performed for the content included in the storage device;
a second indexing mode in which a same thumbnail is generated and applied to the content included in the storage device; and
a third indexing mode in which a respective thumbnail corresponding to individual pieces of content is generated and applied to the individual pieces of the content included in the storage device.

6. The apparatus of claim 1, wherein the indexer is further configured to verify a codec for playing the content, and if the codec is absent, search for a codec corresponding to the content and store information about the content.

7. The apparatus of claim 6, wherein the information about the content comprises at least one of a file size, a resolution, a playback time, a genre, an album, an artist, and a format of the content.

8. The apparatus of claim 1, wherein the indexer is further configured to play content, using the codec, and generate a thumbnail representing the content based on the played content.

9. The apparatus of claim 1, wherein the indexer does not perform a process of generating a thumbnail for the content, based on the indexing mode selected by the user.

10. The apparatus of claim 1, wherein the indexer is further configured to generate a same thumbnail for all of the content, based on the indexing mode selected by the user.

11. The apparatus of claim 1, wherein the indexer is further configured to generate a respective thumbnail corresponding to individual pieces of content, based on the indexing mode selected by the user.

12. The apparatus of claim 1, wherein the indexer is configured to generate a thumbnail using a still frame for representing the content and a successive frame.

13. A method for indexing content, the method comprising:
identifying an indexing mode of content included in a storage device, the indexing mode being selected by a user from among a plurality of indexing modes; and
indexing the content of the storage device based on the identified indexing mode.

14. The method of claim 13, wherein the indexing mode comprises:
a first indexing mode in which a process of generating a thumbnail of the content is not performed.

15. The method of claim 13, wherein the indexing mode comprises:
a second indexing mode in which a same thumbnail is generated and applied to the content included in the storage device.

16. The method of claim 13, wherein the indexing mode comprises:
a third indexing mode in which a respective thumbnail corresponding to individual pieces of content is generated and applied to the individual pieces of the content included in the storage device.

17. The method of claim 13, wherein the indexing mode comprises at least one of:
a first indexing mode in which a process of generating a thumbnail of the content is not performed for the content included in the storage device;
a second indexing mode in which a same thumbnail is generated and applied to the content included in the storage device; and
a third indexing mode in which a respective thumbnail corresponding to individual pieces of content is generated and applied to the individual pieces of the content included in the storage device.

18. The method of claim 13, wherein the indexing of the content comprises:
verifying a codec for playing the content, and if the codec is absent, searching for a codec corresponding to the content and storing information about the content.

19. The method of claim 18, wherein the information about the content comprises at least one of a file size, a resolution, a playback time, a genre, an album, an artist, and a format.

20. The method of claim 13, wherein the indexing of the content comprises playing the content using a codec for playing the content, and generating a thumbnail for representing the content based on the played content.
